(19) United States
(12) Patent Application Publication
(10) Pub. No.: US 2006/0076486 A1
(43) Pub. Date: Apr. 13, 2006

(54) Material surface analyzing method

(75) Inventor: Igor Asanov, Yongin-si (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Electronics Co., Ltd., Suwon-si (KR)

(21) Appl. No.: 11/246,237

(22) Filed: Oct. 11, 2005

(30) Foreign Application Priority Data
Oct. 11, 2004 (KR) 10-2004-0081057

(51) Int. Cl. H01J 40/00

(52) U.S. Cl. 250/305

(57) ABSTRACT

A material surface analyzing method includes measuring composition of elements at each data point after setting M-number data points on a sample surface containing N-number elements, calculating a concentration distance value between the data points using the measured composition of the elements, and determining a phase distribution of the sample surface using the calculated concentration distance value.

### CROSS-REFERENCE TO RELATED PATENT APPLICATION

This application claims the benefit of Korean Patent Application No. 10-2004-0081057, filed on Oct. 11, 2004, in the Korean Intellectual Property Office, the disclosure of which is incorporated herein in its entirety by reference.

### BACKGROUND OF THE DISCLOSURE

1. Field of the Disclosure

The present disclosure relates to a material surface analyzing method, and more particularly, to a material surface analyzing method that can measure the composition and distribution of a phase defined by the combination and arrangement of elements forming a material surface.

2. Description of the Related Art

Micro devices such as semiconductor devices are greatly affected by the type and crystal structure of a thin layer thereof. In the manufacture of such a micro device, it is required to precisely analyze the thin layer structure. In order to identify the reason for inferiority of the manufactured micro device, the components must be precisely analyzed. Therefore, a variety of analyzing apparatuses and methods have been developed to examine the physical properties of the surface and internal structures of the devices.

A transmission electron microscope (TEM), a scanning force microscope (SEM), an atomic force microscope (AFM), and an X-ray diffraction are well known apparatuses for analyzing the structure of the micro device.

The TEM is used to analyze a structure of the test material using transmission or diffraction electrons, which are emitted when the electron beam is projected to the thin layer sample. The SEM is used to object a surface shape of the sample using secondary electrons, which are emitted from the sample when the electron beam is projected to the sample. The AFM is designed to analyze the material using force acting between surface atoms of the tip of the equipment and the sample. The XRD is designed to obtain information with respect to the crystal surface of the test material from a spot pattern obtained by projecting the X-ray almost in a vertical direction to the material.

There is an auger electron spectroscopy (AES) that can analyze the contamination and composition of the surface at a predetermined depth of the sample. As shown in FIG. 1, when the electron beam is projected to the sample, the AES measures the surface components by measuring the kinetic energy of the auger electrons, which are emitted by the interaction between the sample and the electron beam. The AES has a superior analyzing ability for a μm ²-scale area. Therefore, the AES has been used to analyze a material and the damaged portion of a wafer as well as the composition ratio of a material forming a thin layer of the wafer.

When the electron beam is projected to a point of the sample, the auger electrons are emitted from the projected point of the sample. When the sample is not formed of a single element material but a multi-component material, auger electrons of various kinds are emitted. The auger electrons provide information concerning the elements forming the projected point of the sample. The emission density of the auger electrons emitted according to the relative composition ratio of the elements of the sample.

Therefore, by analyzing the emission extent of the auger electrons and the kinetic energy of the auger electrons, the identities of the elements and the relative composition ratio of an electron beam projection point of the sample can be analyzed.

However, the emission extent of the auger electrons is affected by the composition of the sample as well as the surface shape of the sample. Therefore, it is difficult to accurately measure the components of the surface of the sample using the AES or micro XPS. Furthermore, it is also difficult to accurately analyze a phase defined by the types and composition of the elements existing on the sample surface.

### SUMMARY OF THE DISCLOSURE

The present invention may provide a material surface analyzing method that can accurately measure the formation and distribution of a phase defined by the types and composition of the elements existing on the test sample surface.

According to an aspect of the present invention, there may be provided a material surface analyzing method, including: measuring the composition of elements at each data point after setting an M-number of data points on a test sample surface containing N-number elements; calculating a concentration distance value between the data points using the measured composition of the elements; and determining a phase distribution of the test sample surface using the calculated concentration distance value.

The measuring of the composition may include converting composition data of the N-number elements at the M-number of data points into a matrix formation according to following Equation 1.

$$[ \begin{matrix}{X}_{11} & … & {X}_{1 M} \\ … & … & … \\ {X}_{N1} & … & {X}_{NM}\end{matrix} ] . \qquad Equation 1$$

The calculating of the concentration distance value may include calculating a normalization value of each of the data points using the composition of the N-number of elements measured at the data points according to following Equation 2; and calculating the concentration distance value of each data point using the normalization value according to following Equation 3.

$${Z}_{nm} = \frac{{X}_{nm} - {\overline{X}}_{m}}{{σ}_{m}} , \qquad Equation 2$$

where, n indicates 1, 2, 3 . . . N, m denotes 1, 2, 3 . . . M, \overline{Xₘ} indicates a mean value of Xm, i.e., a mean value of a mol % of a specific element, and σₘ indicates a standard deviation with respect to the mean mol% at each data point of the specific element.

$${d}_{i - j} = {( {\sum }_{n = 1}^{N} {( {Z}_{ni} - {Z}_{nj} )}^{2} )}^{1 / 2} ( i , j = 1 , 2 , 3 … m ) . \qquad Equation 3$$

The determining of the phase distribution may include the coupling and clustering of two data points having the lowest concentration distance value and clustering all of the data points by calculating a new concentration distance value using a mean composition of the elements of the coupled two data points and repeatedly coupling two data points having the lowest concentration distance; and determining a phase of the test sample surface.

The determining of the phase may include determining the data points, which have a concentration distance value less than a concentration distance value obtained when a mean value of the squares of the concentration distance values of the data points in a specific group is greater than that of the squares of the concentration distance values of all of the data points, as phases identical to each other.

The material surface analyzing method may further include determining a mean composition of the elements of the data points in the determined phase as the composition of the phase.

The measuring of the composition of the elements may be done by an AES or a micro XPS.

The measuring of the composition of the elements may be done up to a 2-3 nm depth from the test sample surface.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating an example for analyzing surface components of a sample;

FIG. 2A is a flowchart illustrating a method of analyzing a sample surface according to an embodiment of the present invention;

FIG. 2B is a view illustrating a plurality of data points on a surface of a material in a method of analyzing a sample surface according to an embodiment of the present invention;

FIG. 2C is a graph illustrating types and the composition of elements of a sample surface, which are obtained by scanning the sample in a direction by a method of analyzing the sample surface according to an embodiment of the present invention;

FIG. 3 is a graph representing the determination of a phase using data of elements measured at data points (1, 2, 3, 4 . . . 31) of a sample surface containing Gd—Ba—Cu; and

FIG. 4 is a graph representing the determination of a phase using data of elements measured at data points (1, 2, 3, 4 . . . 31) of a sample surface containing Pt—Al.

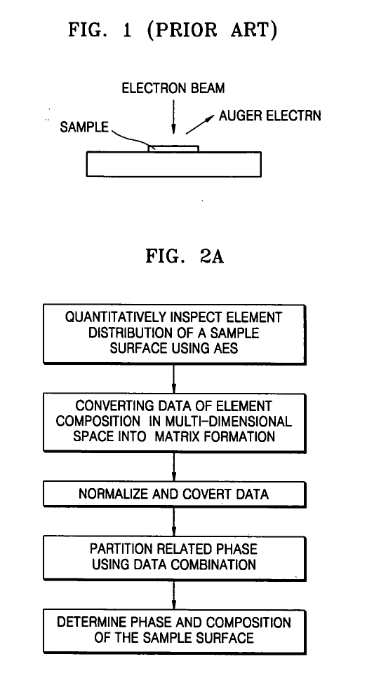

### DETAILED DESCRIPTION OF EXEMPLARY EMBODIMENTS

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will convey in greater detail the concept of the invention to those skilled in the art.

A material surface analyzing method according to the present invention will be described hereinafter with reference to the accompanying drawings.

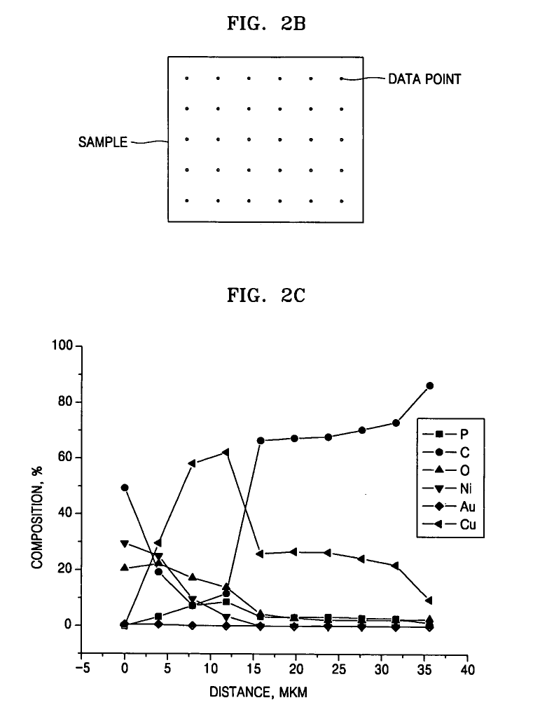

FIG. 2A shows a flowchart illustrating a material surface analyzing method according to an embodiment of the present invention.

The inventive material surface analyzing method may use of AES or a micro XPS. The inventive method will be described hereinafter with reference to an embodiment where AES is used.

Referring to FIG. 2A, the kind and composition of the elements of a sample are quantitatively analyzed at a data point of a sample surface by AES. After the analysis is finished at one data point, the analysis is conducted again at a next data point.

FIG. 2B illustrates a data analyzing location of the sample surface. When the analysis at a location of the sample surface is finished by AES, an electron beam is projected to a next location of the sample surface and the auger electrons emitted by the electron beam projection are analyzed. That is, by conducting the analysis of the auger electrons emitted by the electron beam projections at each location, the kinds and composition ratio of the sample can be detected.

By scanning a whole sample surface according to the above-described method, the quantitative analysis is realized. The scanning of the sample surface may be randomly or orderly performed. For example, In FIG. 2B, the sample analysis is performed by scanning the sample surface from an upper-left point to an upper right point and scanning the lower portion of the scanned portion in a direction. Depending on the size of the sample, the number of the analyzing locations may be varied. In order to precisely perform the analysis, it is preferable to close gaps between the analyzing locations. The AES has a superior analyzing ability for a μm ²-scale area as well as resolving power up to about a 2-3 nm depth. Each gap between the analyzing locations may be less than 9 μm.

FIG. 2C is a graph illustrating the kinds and composition of the elements of the sample surface, which are detected by scanning the sample in a direction by the above-described method.

Referring to FIG. 2C, the graph illustrates the composition and elements at each location of the sample when the scanning is performed in a direction. Each gap between the analyzing locations is about 4 μm. It can be noted from the graph that P, C, O, Ni and Cu are detected and Au is not detected. FIG. 2C shows a result obtained by scanning one of the vertical and horizontal lines of FIG. 2B. By repeating this scanning, all of the locations (data points) are analyzed. As a result, the kinds and composition of the elements at each location of the sample surface can be quantitatively analyzed.

When the quantitative analysis for the element distribution of the sample surface is finished, a data matrix of element concentration in multi-dimensional space is formed. This will be described in more detail hereinafter.

When M-number (1, 2, 3 . . . M) data points are set for a multi-dimensional alloy sample formed of N-number (1, 2, 3 . . . N) elements, data on each composition of the N-number elements at the M-number data points may be obtained. The composition may be varied depending on the data point location on the sample. When the composition is measured for the multi-dimensional alloy sample formed of the N-number (1, 2, 3 . . . N) elements at the M-number (1, 2, 3 . . . N) data points, the data matrix may be formed as shown in Equation 1.

$$[ \begin{matrix}{X}_{11} & … & {X}_{1 M} \\ … & … & … \\ {X}_{N1} & … & {X}_{NM}\end{matrix} ] \qquad Equation 1$$

In Equation 1, the value of each column represents the mol % of an identical element at the data points. The value of each row represents mol % of each element at an identical data point. For example, when the test sample is formed of three elements (N=3), a chemical formula at the data point can be represented as AaBbCc. When the mol % of the elements A, B and C at the first data point is a′,b′,c′, it can be noted from Equation 1 that the X₁₁, X₂₁ and X₃₁ becomes a′, b′ and c′, respectively. Therefore, the data matrix may be formed by applying the mol % of each element at all of the data points.

Next, normalization and conversion of the data are conducted in the multi-dimensional space.

Describing first the normalization of the data, each data point of the sample formed of the N-number elements can be represented as chemical formulas of N-number elements. For example, in the chemical formula AaBbCc of the sample formed of three elements, a, b and c (or a′, b′ and c′) becomes the parameters that may be varied at each of the data points. When these parameters are represented by an axis of coordinates, a three-dimensional coordinate system can be provided. This shows that when the alloy sample is formed of N-number elements, a N-number coordinate system is provided. In the normalization of the data, the mol % values of the elements at each data point are normalized at a single point. The normalized value Z of the data point can be obtained according to Equation 2.

$${Z}_{nm} = \frac{{X}_{nm} - {\overline{X}}_{m}}{{σ}_{m}} \qquad Equation 2$$

In Equation 2, n indicates 1, 2, 3 . . . N, m denotes 1, 2, 3 . . . M, \overline{Xₘ} indicates a mean value of Xm, i.e., a mean value of a mol % of a specific element, and σₘ indicates a standard deviation with respect to the mean mol % at each data point of the specific element. According to Equation 2, the normalized value Znm is a value relating to the composition of the elements.

Next, a data conversion process for calculating a composition distance, i.e., a concentration distance, between the data points using the normalized data point values is preformed. This process is performed to determine a phase of the sample surface by introducing a function representing a relative distance value between the data points. The concentration distance value d between the data points can be determined by Equation 3.

$${d}_{i - j} = {( {\sum }_{n = 1}^{N} {( {Z}_{ni} - {Z}_{nj} )}^{2} )}^{1 / 2} \qquad Equation 3$$

Here, each of i and j has a value 1, 2, 3 . . . M. Referring to Equation 3, it can be noted that the concentration distance value d is calculated by adding a difference of normalized values of the elements between all of the data points. Therefore, the concentration distance value d between the data points may be determined. The concentration distance value d in Equation 3 is not the distance between the data point locations on the sample surface but an extent of similarity of the composition distribution between the elements at each data point. That is, by calculating the concentration distance values, a concentration distance matrix of data points can be obtained.

A method of determining a phase using the concentration distance values d of the data points will be described hereinafter.

Generally, in the case of alloy formed of identical elements, a phase of the alloy is varied according to the composition of the elements. When the phase appears identically, the composition of each element very similarly appears. That is, the composition of the identical elements in a phase is remarkably different from that of the different elements in the phase. This can be identified by the phase transition diagram. Therefore, on the multiple-component alloy surface formed of the N-number elements, the M-number data points may be represented in the form of condensation in an N-dimensional space by the normalization process.

When the sample surface is composed of more than two phases, and the composition is varied when the alloy is formed of identical elements, the data points are distributed in the N-dimensional space while forming a cluster around more than two points. Therefore, the number of the clusters is determined by representing the concentration distribution of the normalized data as a distance and the clusters are regarded as the phases on the sample surface. A clustering process of clustering the data points similar in the composition and a phase determining process of determining the phase by repeating the clustering process are first performed. By these processes, the phase of the sample surface is determined and the composition and distribution of the elements defining the phase can be measured.

The phase determining process according to the present invention will be described in more detail hereinafter.

First, two data points having the lowest concentration distance value are first determined. This can be realized by comparing the concentration distance values between the data points, which are obtained through Equation 3. This is the clustering process.

Second, a new concentration distance value between the determined two data points using a mean mol % of the elements. By doing this, the concentration distance matrix is newly obtained through Equation 3.

Third, the first and second processes are repeated using the new concentration distance. This process is repeatedly performed until the clustering for all of the data points is completed.

Fourth, it is determined that what distance will be determined as a concentration distance between two data points each defining a single phase. As a result, the number of phases, components and composition of the test sample surface are determined.

The concentration distance stated in the fourth process is determined by Equation 4.

$${\overline{d}}_{c}^{2} = \frac{{W}_{c}}{c} < \frac{S}{M} \qquad Equation 4$$

Where, c is the number of the data points in a specific cluster, Wc is the sum of squares of the concentration distances of the data points in the specific cluster, S is the sum of the squares of the concentration distances of all of the data points, and M is the number of all of the data points. The Wc and S are calculated by Equation 5.

$$\begin{matrix}Equation 5 \\ & \\ {W}_{c} = {\sum }_{a = 1}^{c} {d}^{2} ( {x}_{a} , {\overline{x}}_{c} ) & ( a ) \\ S = {\sum }_{i = 1}^{M} {d}^{2} ( {x}_{i} , \overline{x} ) & ( b )\end{matrix}$$

Where, \overline{Xc_{c}} a mean mol % of the data points in the specific cluster. That is, it can be noted that the Wc indicates the mean mol % of the data points in the cluster as well as the sum of squares of the concentration distances between the data points in the cluster.

The concentration distance values in (a) and (b) of Equation 5 are calculated by Equations 2 and 3, respectively.

Referring to Equation 4, the mean value of the squares of the concentration distance values of the data points in the cluster is less than that of the squares of the concentration distance values of all of the data points. However, in the course of enlarging the range of the cluster, there may be a case where the mean value of the squares of the concentration distance values of the data points in the cluster becomes greater than that of the squares of the concentration distance values of all of the data points. Therefore, based on the concentration distance values determined at this point, the phase existing on the test sample surface may be determined. As a result, the mean composition of the elements of each phase may be the value obtaining by the composition of the elements of the data points in the cluster defining the phase.

An example of a material surface analyzing method using the AES according to the present invention will be described in more detail hereinafter.

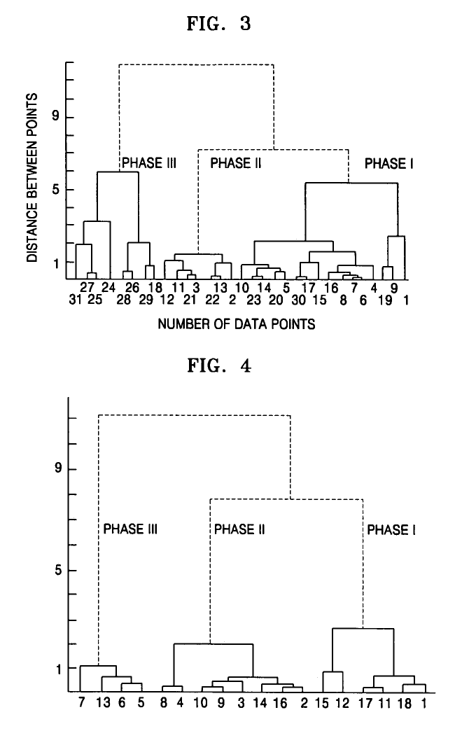

FIG. 3 shows a graph representing the determination of a phase using data of elements measured at data points (1, 2, 3, 4 . . . 31) of a test sample surface containing Gd—Ba—Cu.

Referring to FIG. 3, it can be noted that the data point coupling is performed in the order of the concentration distance of the 31 (M=31) data points. The data point couples (27, 25), (28, 26), (21, 3), (22, 13), (23, 14), (30, 17) and (7, 6) on the horizontal axis are data points most similar in an element concentration distribution. That is, it can be noted that the concentration distance value is less than 0.5.

Next, concentration distance values of other data points are calculated and coupled by identifying middle values of the data points as new data points. This is the clustering process. As this process is repeated, it can be noted that the range of the cluster is enlarged and the concentration distance between the coupled data points is increased higher and higher. It can be also noted that the concentration distance for determining the phase becomes 6.5 as in Equation 4 and there are three clusters at a concentration distance value less than 6.5 as shown in FIG. 3. Therefore, the three clusters are determined as phases different from each other.

When a mean concentration value of all of the elements constituting the data points defining the three phases is calculated, the concentration of the elements of each phase, i.e., the mol %, can be calculated.

Table 1 shows mole % of the elements of each phase, which is calculated by the above-described method.

TABLE 1

| Ba(mol %) | Cu(mol %) | Gd(mol %) |
|---|---|---|
| 53 | 42 | 5 |
| 1 | 19 | 80 |
| 46 | 39 | 15 |

FIG. 4 is a graph representing the determination of a phase using data of elements measured at data points (1, 2, 3, 4 . . . 18) of a test sample surface containing Pt—Al.

Referring to FIG. 4, the data point coupling is performed in the order of the concentration distance of the 18 (M=18) data points.

The data point couples (6, 5), (8, 4), (10, 9), (16, 2), (17, 11), and (18, 1) on the horizontal axis are data points most similar in an element concentration distribution.

Next, concentration distance values of other data points are calculated and coupled by identifying middle values of the data points as new data points. This process is repeated for all of the data points. As shown in FIG. 4, it can be noted that the data point groups (7, 13, 6, 5), (8, 4, 10, 9, 3, 14, 16, 2) and (15, 12, 17, 11, 18, 1) are independently clustered in the concentration distance value less than 3. The concentration distance between the groups is 8 or 11. Therefore, each of the groups is determined as a single phase. As shown in FIG. 4, since the concentration distances between the three groups is very large, it can be noted that each of the three groups is determined as the single phase even without calculating the concentration distance values determining the phases using Equations.

Table 2 shows mole % of the elements of each phase, which is calculated by the above-described method.

TABLE 2

| Pt(mol %) | Al(mol %) |
|---|---|
| 70 | 30 |
| 43 | 57 |
| 12 | 88 |

In conclusion, it can be noted that the elements of the sample surface, the composition of the elements, and the phase existing on the test sample surface can be determined.

According to the present invention, it becomes possible to determine the phase of the sample surface using the composition and composition data of the elements that are measured by conventional AES or micro XPS.

In addition, the elements constituting the sample surface, the composition of the elements, the phase existing on the sample surface, and the irregular property of the sample surface can be identified.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A material surface analyzing method comprising:
measuring composition of elements at each data point after setting M-number data points on a sample surface containing N-number elements;
calculating a concentration distance value between the data points using the measured composition of the elements; and
determining a phase distribution of the sample surface using the calculated concentration distance value.

2. The material surface analyzing method of claim 1, wherein the measuring of the composition comprises converting composition data of the N-number elements at the M-number data points into a matrix formation according to following Equation 1.
$$[ \begin{matrix}{X}_{11} & … & {X}_{1 M} \\ … & … & … \\ {X}_{N1} & … & {X}_{NM}\end{matrix} ] . \qquad Equation 1$$

3. The material surface analyzing method of claim 1, wherein the calculating of the concentration distance value comprises:
calculating a normalization value of each of the data points using the composition of the N-number elements measured at the data points according to following Equation 2; and
calculating the concentration distance value of each data point using the normalization value according to following Equation 3.
$${Z}_{nm} = \frac{{X}_{nm} - {\overline{X}}_{m}}{{σ}_{m}} , \qquad Equation 2$$
where, n indicates 1, 2, 3 . . . N, m denotes 1, 2, 3 . . . M, \overline{Xₘ} indicates a mean value of Xm, i.e., a mean value of a mol % of a specific element, and σₘ indicates a standard deviation with respect to the mean mol % at each data point of the specific element.
$${d}_{i , j} = {( {\sum }_{n = 1}^{N} {( {Z}_{ni} - {Z}_{nj} )}^{2} )}^{1 / 2} \\ ( i , j = 1 , 2 , 3 … m ) . \qquad Equation 3$$

4. The material surface analyzing method of claim 1, wherein the determining of the phase distribution comprises:
coupling and clustering two data points having the lowest concentration distance value; and
clustering all of the data points by calculating a new concentration distance value using a mean composition of the elements of the coupled two data points and repeatedly coupling two data points having the lowest concentration distance; and
determining a phase of the sample surface.

5. The material surface analyzing method of claim 4, wherein the determining of the phase comprises determining the data points, which have a concentration distance value less than a concentration distance value obtained when a mean value of the squares of the concentration distance values of the data points in a specific group is greater than that of the squares of the concentration distance values of all of the data points, as phases identical to each other.

6. The material surface analyzing method of claim 4, further comprising determining a mean composition of the elements of the data points in the determined phase as the composition of the phase.

7. The material surface analyzing method of claim 1, wherein the measuring of the composition of the elements is done by an AES or a micro XPS.

8. The material surface analyzing method of claim 1, wherein the measuring of the composition of the elements is done up to a 2-3 nm depth from the sample surface.

9. The material surface analyzing method of claim 2, wherein the measuring of the composition of the elements is done by an AES or a micro XPS.

10. The material surface analyzing method of claim 3, wherein the measuring of the composition of the elements is done by an AES or a micro XPS.

11. The material surface analyzing method of claim 4, wherein the measuring of the composition of the elements is done by an AES or a micro XPS.

12. The material surface analyzing method of claim 5, wherein the measuring of the composition of the elements is done by an AES or a micro XPS.

13. The material surface analyzing method of claim 6, wherein the measuring of the composition of the elements is done by an AES or a micro XPS.

14. The material surface analyzing method of claim 2, wherein the measuring of the composition of the elements is done up to a 2-3 nm depth from the sample surface.

15. The material surface analyzing method of claim 3, wherein the measuring of the composition of the elements is done up to a 2-3 nm depth from the sample surface.

16. The material surface analyzing method of claim 4, wherein the measuring of the composition of the elements is done up to a 2-3 nm depth from the sample surface.

17. The material surface analyzing method of claim 5, wherein the measuring of the composition of the elements is done up to a 2-3 nm depth from the sample surface.

18. The material surface analyzing method of claim 6, wherein the measuring of the composition of the elements is done up to a 2-3 nm depth from the sample surface.

19. The material surface analyzing method of claim 7, wherein the measuring of the composition of the elements is done up to a 2-3 nm depth from the sample surface.

20. The material surface analyzing method of claim 8, wherein the measuring of the composition of the elements is done up to a 2-3 nm depth from the sample surface.
